(19) United States
(12) Patent Application Publication
(10) Pub. No.: US 2026/0356281 A1
(43) Pub. Date: Nov. 12, 2026

(54) ROAD SURFACE DRAWING SYSTEM

(71) Applicant: Stanley Electric Co., Ltd., Tokyo (JP)

(72) Inventors: Naoya UCHIYAMA, Tokyo (JP); Yuki KOBAYASHI, Tokyo (JP); Toshihiko YAJIMA, Tokyo (JP); Marino SHIBUYA, Tokyo (JP); Kosuke HASEGAWA, Tokyo (JP)

(21) Appl. No.: 18/997,005

(22) PCT Filed: Jul. 11, 2023
(86) PCT No.: PCT/JP2023/025606

§ 371 Date: Jan. 18, 2025

(30) Foreign Application Priority Data
Jul. 22, 2022 (JP) 2022-116975

(51) Int. Cl. B60Q 1/24; B60Q 1/50; B60Q 11/00

(52) U.S. Cl. CPC B60Q 1/24; B60Q 1/525; B60Q 11/00

(57) ABSTRACT

A road surface drawing system including: a camera for photographing a forward space of a vehicle; a controller detecting a pedestrian present in the forward space by the camera, detecting a white line on a road ahead, and controlling light irradiation onto the road based on the detection results; and a lamp unit that irradiates light onto the road by the controller, where the controller controls the lamp unit such that, when the pedestrian is present and distance between the pedestrian and the vehicle is less than a threshold value, a first bright line is irradiated to a position on the road which corresponds to the pedestrian's position, and where the first bright line is a linear light beam which extends along the direction of the white line provided at an end of the vehicle's driving lane, and is irradiated to overlap the white line.

This application is a U.S. National Stage Application under 35 U.S.C § 371 of International Patent Application No. PCT/JP2023/025606 filed Jun. 11, 2023, which claims the benefit of priority under 35 U.S.C. § 119 to Japanese Patent Application No. 2022-116975 filed Jul. 22, 2022, the disclosures of all of which are hereby incorporated by reference in their entireties.

### TECHNICAL FIELD

The present disclosure relates to a road surface drawing system.

### BACKGROUND ART

Japanese Unexamined Patent Application Publication No. 2008-143510 (Patent Document 1) describes an attention calling irradiation apparatus that irradiates a road surface with light that indicates the direction of a person presumed to be a danger from an own vehicle and the distance to the person, thereby alerting both a driver and the person regardless of the color of the person's clothing. As the light irradiated onto the road surface (road surface drawing), T-shaped, Y-shaped, arrow-shaped light or the like which are irradiated so as to extend toward the person are described.

### PRIOR ART DOCUMENT

### Patent Document

[Patent Document 1] Japanese Unexamined Patent Application Publication No. 2008-143510

### SUMMARY OF THE INVENTION

### Technical Problem

As described in the prior art described in Patent Document 1, when a complex character drawing such as a T-shape is irradiated, the character drawing is angled or large in size, making it difficult for the driver of the own vehicle to narrow down the location as to where to focus, making it difficult to recognize the exact position of a pedestrian. Further, as the own vehicle approaches the pedestrian, the complex character drawing such as the T-shape also moves, however since only the angle of the character drawing changes, it is difficult for the driver to recognize sense of distance to the pedestrian. In a specific aspect, it is an object of the present disclosure to provide a road surface drawing system that enables the driver of the own vehicle to grasp the situation of a pedestrian with good visual recognition.

### Solution to the Problem

A road surface drawing system according to one aspect of the present disclosure is a road surface drawing system including: (a) a camera for photographing a forward space of a vehicle; (b) a controller configured to detect a pedestrian present in the forward space of the vehicle based on image data obtained by the camera, to detect a white line on a road ahead of the vehicle, and to control irradiation of light onto the road based on each of the detection results; and (c) a lamp unit that irradiates light onto the road under the control of the controller, (d) where the controller is configured to control the lamp unit such that, when the pedestrian is present and relative distance between the pedestrian and the vehicle is equal to or less than a threshold value, a first bright line is caused to irradiate to a position on the road which corresponds to the position of the pedestrian, and (e) where the first bright line is a linear light beam which extends along the direction of the white line provided at an end portion of the vehicle's driving lane or oncoming lane on the road, and is caused to irradiate so as to overlap the white line.

According to the above configuration, there is provided a road surface drawing system that enables to grasp the situation of a pedestrian (exact position and distance) with good visual recognition.

### BRIEF DESCRIPTION OF THE DRAWINGS

FIG. 1 is a block diagram showing the configuration of a road surface drawing system according to one embodiment.

FIG. 2(A) is a diagram schematically showing an installation example of each lamp unit.

FIG. 2(B) is a diagram schematically showing a configuration example of the lamp unit.

FIG. 3 is a diagram showing a configuration example of a computer system.

FIG. 4 is a flowchart showing an operation procedure of a road surface drawing system.

FIG. 5(A) to FIG. 5(C) are diagrams for explaining a drawing mode of a bright line.

FIG. 6(A) to FIG. 6(C) are diagrams for explaining a drawing mode of a bright line.

FIG. 7(A) to FIG. 7(C) are diagrams for explaining a drawing mode of a bright line.

FIG. 8(A) to FIG. 8(C) are diagrams for explaining a drawing mode of a bright line.

FIG. 9(A) and FIG. 9(B) are diagrams for explaining a drawing mode of a bright line.

FIG. 10(A) to FIG. 10(C) are diagrams for explaining a drawing mode of a bright line.

FIG. 11(A) to FIG. 11(B) are diagrams for explaining a drawing mode of a bright line.

FIG. 12(A) to FIG. 12(C) are diagrams for explaining a drawing mode of a bright line.

FIG. 13 is a flowchart showing an operation procedure of a road surface drawing system.

### MODE FOR CARRYING OUT THE INVENTION

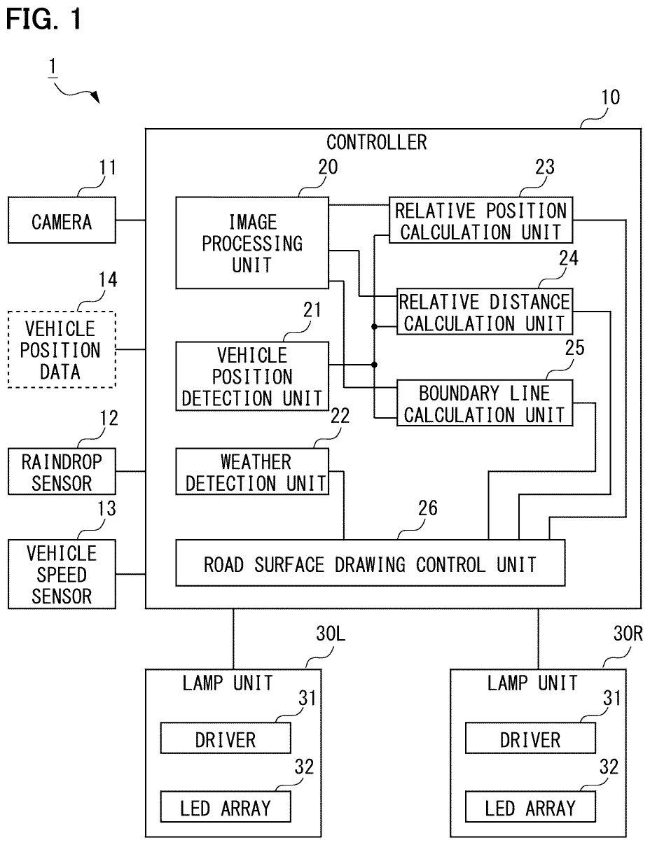

FIG. 1 is a block diagram showing the configuration of a road surface drawing system according to one embodiment. The road surface drawing system 1 according to the present embodiment is configured to include a controller 10, a camera 11, a raindrop sensor 12, a vehicle speed sensor 13, and a pair of lamp units 30L, 30R. This road surface drawing system 1 is installed in the front part of a vehicle and draws a bright line (line-like light) on a road surface in front of the vehicle which corresponds to the situation of a pedestrian existing in front of the vehicle. The pedestrian includes not only a person who is walking, but also a person who is riding a bicycle.

Controller 10 controls light irradiation of each headlamp unit 30L, 30R. This controller 10 can be configured using a computer system equipped with, for example, a processor (CPU: Central Processing Unit), a ROM (Read Only Memory), a RAM (Random Access Memory), a storage device such as a flash memory, an input/output interface, etc. Controller 10 of the present embodiment is capable of performing a specified function by having the processor read and execute a program previously stored in the storage device (or ROM).

Camera 11 photographs an image of the forward space of an own vehicle and generates image data. Based on this image data, an image processing unit 20 of controller 10 detects the situation such as position of the pedestrian. Here, note that the function of image processing unit 20 may be provided on the side of camera 11.

Raindrop sensor 12 detects the amount of rainfall where the own vehicle is present, and outputs a signal (or data) indicating changes according to the amount of rainfall. As raindrop sensor 12, a variety of publicly known raindrop sensors can be used. As one example, a sensor described in Japanese Unexamined Patent Application Publication No. 2006-29807 can be used, where a sensor is installed inside of an own vehicle's windshield and uses optical techniques to detect raindrops adhering to the outer surface of the windshield.

Vehicle speed sensor 13 detects vehicle speed of the own vehicle and outputs a vehicle speed signal (vehicle speed pulse). If the own vehicle already has a vehicle speed sensor for other purposes, it may be used as vehicle speed sensor 13.

Vehicle position data 14 is generated by a position detection means (not shown) such as a car navigation system or a GPS sensor equipped in the own vehicle, and is input to a vehicle position detection unit 21 of controller 10.

The pair of lamp units 30L, 30R are mounted at specified positions on the left and right sides of the front part of the own vehicle, and operate in response to control signals provided by controller 10 to irradiate a straight line of light (line-like light) to a desired position in front of the own vehicle. Each lamp unit 30L, 30R has a driver 31 and an LED array 32 driven by driver 31.

Controller 10 described above is configured to include image processing unit 20, vehicle position detection unit 21, a weather detection unit 22, a relative position calculation unit 23, a relative distance calculation unit 24, a boundary line calculation unit 25, and a road surface drawing control unit 26, which are functional blocks realized by program execution.

Image processing unit 20 performs image recognition processing on the image data generated by camera 11 to detect the situation ahead of the vehicle, such as the position of a pedestrian, the position of a front vehicle (a preceding vehicle or an oncoming vehicle), and white lines on the road.

Vehicle position detection unit 21 detects the position of the own vehicle based on vehicle position data 14. In order to obtain the position of the own vehicle, this vehicle position data 14 may be configured to include data from a car navigation system, and it is also possible to calculate whether the own vehicle is located in a city, on a road with a straight line of 100 m or more, or on a road with a straight line of less than 100 m from the map information of the car navigation system. The definition of a road in this disclosure is a road with good visual recognition in which the driver can visually recognize, therefore it includes not only a straight road but also a curve as long as its visibility is good. In other words, a crossroad and a S-shaped curve with good visual recognition ahead are also included as a road.

Weather detection unit 22 detects weather conditions, specifically amount of rainfall, based on the output of raindrop sensor 12. When the amount of rainfall exceeds a predetermined value, weather detection unit 22 outputs such a signal to that effect to road surface drawing control unit 26.

Relative position calculation unit 23 detects position and shape of a white line ahead of the own vehicle based on the image recognition results from image processing unit 20.

Relative distance calculation unit 24 calculates relative distance between a pedestrian and the own vehicle based on the current position detected by the vehicle position detection on the basis of the vehicle position data and the image recognition results by image processing unit 20.

When there is no white line on the road surface, boundary line calculation unit 25 calculates a boundary line which is a virtual line that can replace a white line, based on the image recognition results by image processing unit 20.

Road surface drawing control unit 26 generates a control signal for drawing a bright line on the road surface based on the position and shape of the white line calculated by relative position calculation unit 23, the relative distance between the pedestrian and the own vehicle calculated by relative distance calculation unit 24, the boundary line calculated by boundary line calculation unit 25, and the weather condition detected by weather detection unit 22, and outputs the control signal to each lamp unit 30L, 30R.

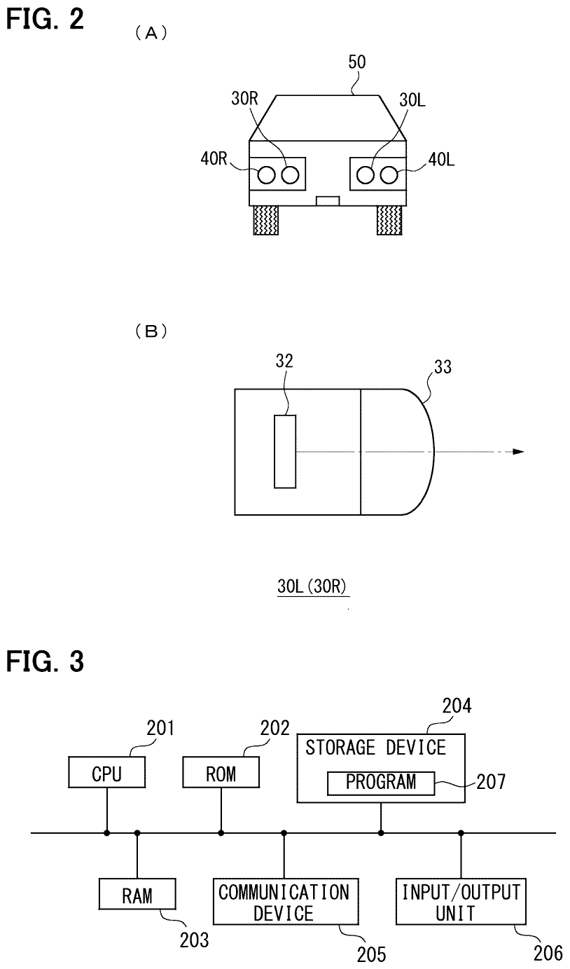

FIG. 2(A) is a diagram schematically showing an installation example of each lamp unit. Each lamp unit 30L, 30R is disposed in a predetermined position on the left and right sides in the front of own vehicle 50. In the example shown, lamp units 30L, 30R are respectively disposed adjacent to lamp units 40L, 40R for irradiating a high beam and a low beam.

FIG. 2(B) is a diagram schematically showing a configuration example of the lamp unit. Lamp unit 30L (30R) shown in the illustrated example is configured to include an LED array 32 having a plurality of LEDs (Light Emitting Diodes) arranged in two directions, and a lens 33 that projects light emitted from LED array 32. LED array 32 is arranged so that its center roughly aligns with the focal point of lens 33. By individually controlling lighting state of each LED in LED array 32 by driver 31, it is possible to irradiate a bright line onto a desired position on the road surface. The irradiation range of road surface drawing refers to a range which includes, in the forward and backward direction, at least a range including both a high beam range and a low beam range (within 100 m from the vicinity in front of the vehicle, or more than 100 m), in the left and right direction, at least a range including driving lanes (including the white line on the driving lane side and the center white line), and further a range including oncoming lanes (including the white line on the oncoming lane side). In the present embodiment, the forward and backward direction of the range includes 100 m from the front of the own vehicle, and the left and right direction of the range includes both the driving lanes and the oncoming lanes.

Here, the configuration of lamp unit 30L etc. is not limited thereto and various publicly known configurations can be adopted. For example, a lamp unit configured by combining a light source bulb with a reflector and a shielding plate may be used. Further, a lamp unit having a light source and a liquid crystal element and that can individually control the light transmission state of each pixel of the liquid crystal element may be used. Furthermore, a lamp unit having a light emitting element such as a laser diode and a scanning element such as a mirror device that scans the light emitted from the light emitting element and that can control the timing of turning the light emitting element on and off and the scanning timing by the scanning element may be used.

FIG. 3 is a diagram showing a configuration example of a computer system. The controller 10 described above can be configured, for example, using the computer system as shown in the diagram. A CPU (Central Processing Unit) 201 performs information processing by reading and executing a program 207 stored in a storage device 204. A ROM (Read Only Memory) 202 stores a basic control program or the like required for the operation of CPU 201. A RAM (Temporary Storage Memory) 203 temporarily stores data required for the information processing of CPU 201. Storage device 204 is a large-capacity storage device for storing data, and is comprised of a hard disk drive, a solid-state drive, or the like. A communication device 205 performs processing related to data communication with other external devices. An input/output unit 206 is an interface for connecting to external devices, and in the present embodiment, is used for connection between camera 11, raindrop sensor 12, vehicle speed sensor 13, and each lamp unit 30L, 30R. CPU 201 and the like are connected to each other via a bus so that they can communicate with each other.

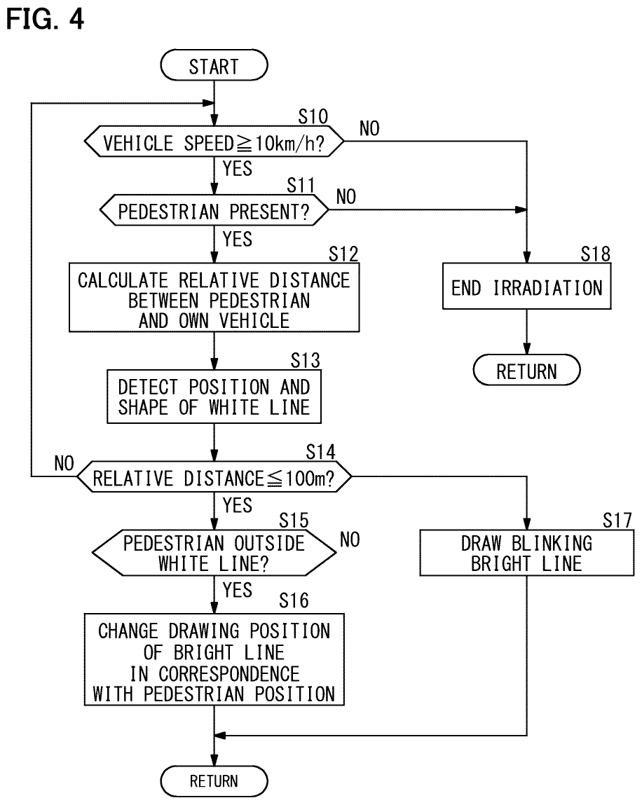

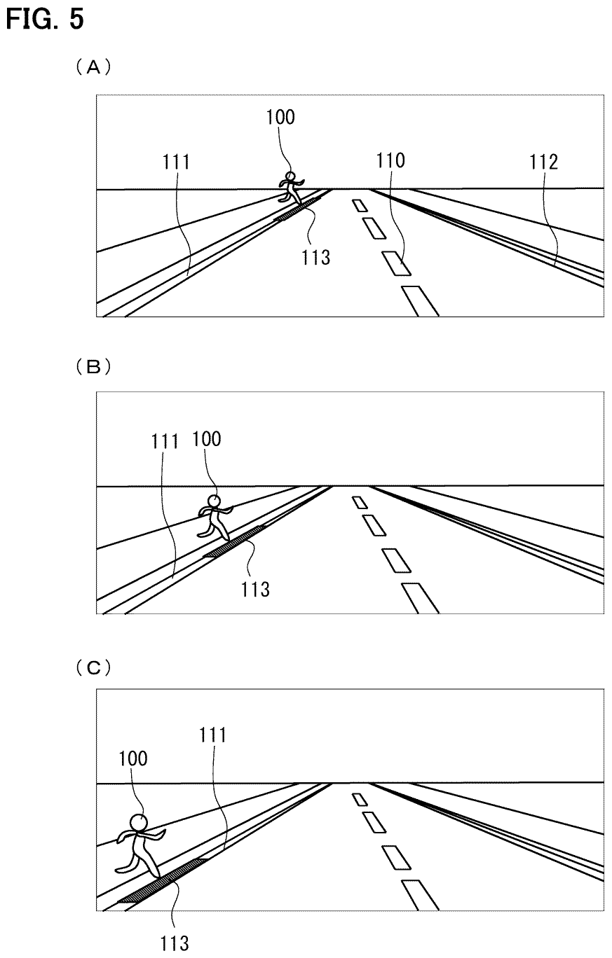

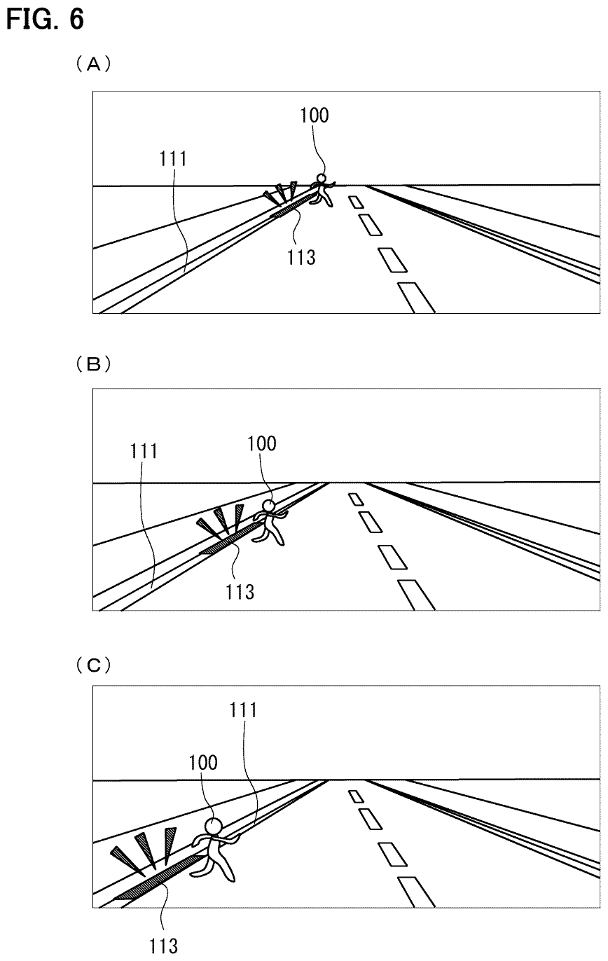

FIG. 4 is a flowchart showing an operation procedure of a road surface drawing system. Here, the order of each process can be changed as long as there is no inconsistency in the control results, and other processes not described may be added, and these modes are not excluded. First, as a basic drawing mode, as shown in FIG. 5(A) to FIG. 5(C) and FIG. 6(A) to FIG. 6(C) which show the road ahead as seen from the own vehicle, operating procedure of road surface drawing system 1 will be described while referring to a mode in which a short bright line (first bright line) 113 whose drawing position changes according to the position of a pedestrian 100 is drawn so as to overlap white line 111, and in which bright spot 113 is caused to blink when pedestrian 100 is inside (on the road side) of white line 111.

When the own vehicle speed detected by vehicle speed sensor 13 is 10 km/h or greater (step S10; YES), and when a pedestrian is detected in front of the own vehicle by image processing unit 20 based on the image data obtained by camera 11 (step S11; YES), relative distance calculation unit 24 calculates relative distance between the pedestrian and the own vehicle based on the current position detected by the vehicle position detection and the image processing results (step S12). Further, relative position calculation unit 23 also detects the positions and shapes of white lines 110, 111, 112 in front of the own vehicle based on the image recognition results by image processing unit 20 (step S13). The calculated relative distance, position, and shape data are temporarily stored in a memory.

When relative distance between the pedestrian and the own vehicle is greater than a predetermined threshold value (100 m, for example) (step S14; NO), no bright line is drawn on the road surface and the process returns to step S10. In the present embodiment, since it is assumed that monitoring begins within the high beam range, the predetermined threshold value is set to 100 m, however in urban areas, since roads with good visual recognition are short, there may not be a road 100 meters ahead. In such a case, it is possible to assume that monitoring begins near the low beam range and may set the predetermined threshold value between 30 m and 50 m (40 m, for example). If it is known in advance from map information of the car navigation system or the like that the own vehicle's position is in an urban area or on a road with good visual recognition having distance of less than 100 m, the predetermined threshold may be changed automatically.

When relative distance between the pedestrian and the own vehicle is equal to or less than the threshold value (step S14; YES) and when position of the pedestrian is outside the white line (step S15; YES), road surface drawing control unit 26 generates a control signal to draw a bright line of a predetermined length on the white line which corresponds to the pedestrian's position, and outputs this control signal to each lamp unit 30L, 30R (step S16). The bright line (short bright line) 113 here is a linear light that is approximately parallel to white line 111, i.e., approximately parallel to the extended direction of the road. It is preferable that the width of bright line (short bright line) 113 is set to be approximately the same as that of white line 111 or slightly wider than white line 111 at each position where it is drawn. This is because, in a case where white line 111 becomes same or similar color as the drawn bright line 113 due to deterioration or dirt, or in a case where the brightness of bright line (short bright line) 113 is insufficient, if bright line (short bright line) 113 is wider than the width of white line 111, then the drawn bright line 113 will be easier to visually recognize by the driver of the own vehicle or by a pedestrian due to the amount that extends beyond white line 111. Further, the length of the bright line (short bright line) 113 is a length necessary and sufficient to allow the position of a pedestrian to be visually recognized (a length that is equal to or greater than the width of a human which is 0.5 m, and less than or equal to 2 m), and is preferably, for example, about 1.5 m, which is about the height of a human or the length with hands outstretched. When the distance to the drawing position is as far away as 100 m, a bright line size that is about the same width or slightly wider than the white line and 1.5 m long may be difficult for the driver of the own vehicle to visually recognize, so the width and length may be changed, for example, to 1.5 to 2 times to improve visual recognition. When the relative distance becomes shorter (for example, equal to or less than 50 m), the width and length may be shortened and returned to the predetermined width and length (the width and length may be adjusted gradually or in stages). This is achieved by generating a control signal so that when relative distance calculation unit 24 is able to detect that the relative distance is far, road surface drawing control unit 26 draws bright line (short bright line) 113 with an adjusted width and length, and outputs this control signal to each lamp unit 30L, 30R.

For example, as shown in FIG. 5(A), when the position of pedestrian 100 is relatively far from the own vehicle, bright line 113 is drawn so as to overlap a portion of white line 111 which corresponds to the position of pedestrian 100. Further, as shown in FIG. 5(B) and FIG. 5(C), when the position of pedestrian 100 and the position of the own vehicle becomes relatively close, bright line (short bright line) 113 is drawn so as to overlap a portion of white line 111 which corresponds to the closer position of the pedestrian 100. Thus, by irradiating the short bright line, the driver can intuitively recognize the position of the pedestrian, and furthermore, since the short bright line is irradiated so as to overlap the white line, the short bright line appears to shine on the continuous white line, allowing the driver to recognize relative distance between the own vehicle and the pedestrian, i.e., the exact position of the pedestrian.

When relative distance between the pedestrian and the own vehicle is equal to or less than a threshold value (step S14; YES) and the position of the pedestrian is inside the white line, i.e., inside the road (step S15; NO), road surface drawing control unit 26 generates a control signal which causes to irradiate a predetermined length of bright line (short bright line) in a blinking manner on the white line which corresponds to the pedestrian's position, and outputs this control signal to each lamp unit 30L, 30R (step S17). As a result, due to a change in the way the bright line is irradiated, this allows the driver to intuitively recognize the change of the pedestrian's situation (in this case, whether or not the pedestrian has entered within the road) which enables the driver to drive while paying attention to the pedestrian.

For example, as shown in FIG. 6(A), when the position of pedestrian 100 is relatively far from the own vehicle, bright line 113 is drawn in a blinking manner so as to overlap the portion of white line 111 that corresponds to the position of pedestrian 100. Further, as shown in FIG. 6(B) and FIG. 6(C), when the position of pedestrian 100 and the position of the own vehicle becomes relatively close, bright line 113 is drawn in a blinking manner so as to overlap the portion of white line 111 that corresponds to the closer position of pedestrian 100.

Thereafter, the process returns to step S10. By repeating the processes from step S10 onward, the drawing position of bright line 113 is changed in accordance with the change in the relative position of pedestrian 100. Further, when the pedestrian's position moves from outside the white line to inside the white line, bright line 113 is switched to blinking irradiation. For example, if pedestrian 100 is outside the white line far from the own vehicle at one timing, and pedestrian 100 moves inside the white line at the next timing, the drawing mode transitions from the drawing mode (continuous irradiation) shown in FIG. 5(A) to the drawing mode (blinking irradiation) shown in FIG. 6(A). Further, when pedestrian 100 who is far from the own vehicle and outside the white line at one timing approaches the own vehicle to become relatively close at the next timing, and then pedestrian 100 moves inside the white line at the following timing, the drawing mode transitions from the drawing mode shown in FIG. 5(A) (continuous irradiation) to the drawing mode shown in FIG. 5(B) (continuous irradiation), then to the drawing mode shown in FIG. 6(B) (blinking irradiation). As a result, since the short bright lines are irradiated so as to overlap the white line, the short bright line appears to be approaching closer and closer as it transitions along the continuous white line (and it transitions in one direction), thereby allowing the driver to intuitively recognize the distance between the pedestrian and the driver.

On the other hand, when the vehicle speed is less than 10 km/h (step S10; NO), or when the vehicle speed is 10 km/h or more but there are no pedestrians (step S11; NO), road surface drawing control unit 26 ends irradiation of bright lines (step S18). Here, if bright line irradiation had not been performed previously, such state is maintained. In the present embodiment, step S10 has been set to “whether the vehicle speed is 10 km/h or more”, but the vehicle speed is merely one example, and step S10 can be set to YES when the vehicle is moving, or, to take an extreme example, step S10 can even be set to YES when the ignition switch is ON prior to driving.

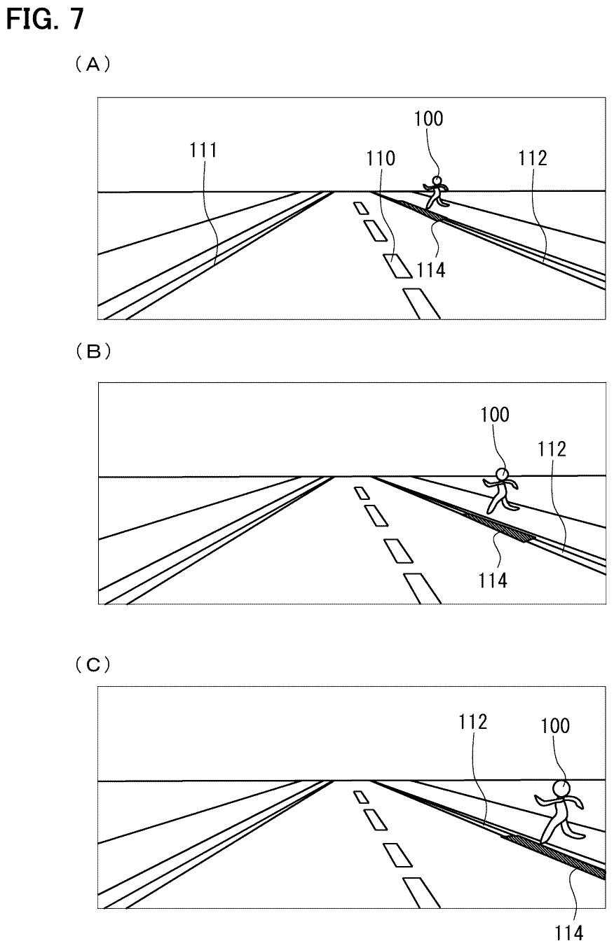

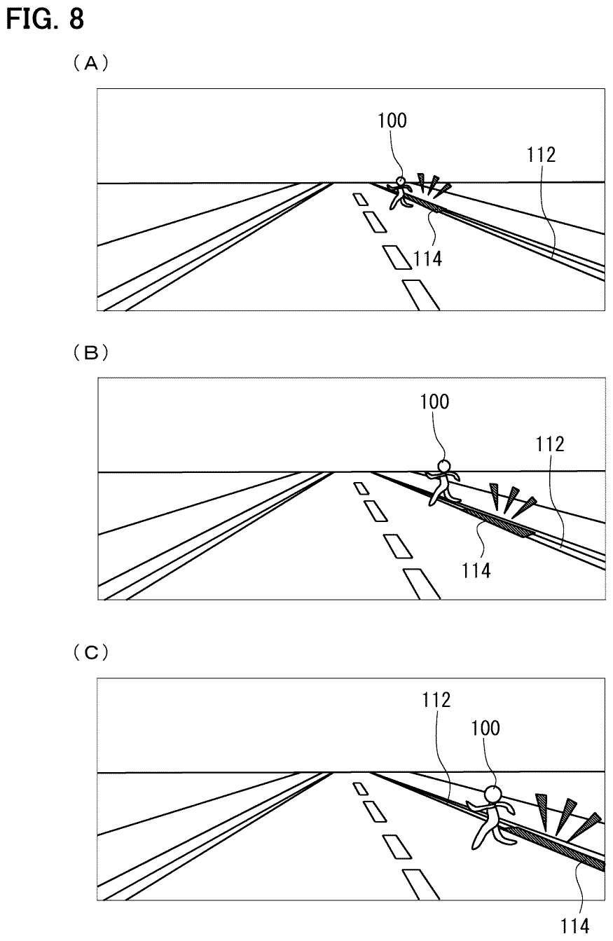

FIG. 7(A) to FIG. 7(C) and FIG. 8(A) to FIG. 8(C) are diagrams for explaining examples of the mode in which bright lines are drawn. Each diagram shows the state of road ahead as seen from the own vehicle. According to the above-described operational procedure, just as bright line irradiation can be performed when a pedestrian is near the white line of the side in which the own vehicle is traveling, bright line irradiation can be performed when a pedestrian is near the white line on the side of the oncoming lane.

For example, as shown in FIG. 7(A), when the position of pedestrian 100 is relatively far from the own vehicle, a bright line (first bright line) 114 is irradiated so as to overlap a portion of a white line 112 in the oncoming lane that corresponds to the position of pedestrian 100. Further, as shown in FIG. 7(B) and FIG. 7(C), when the position of pedestrian 100 and the position of the own vehicle becomes relatively close, bright line 114 is irradiated so as to overlap the portion of white line 112 of the oncoming lane side that corresponds to the closer position of pedestrian 100.

Further, for example, as shown in FIG. 8(A), when the pedestrian 100 is relatively far from the own vehicle and is inside the white line (i.e., inside the oncoming lane), bright line 114 is irradiated in a blinking manner so as to overlap a portion of white line 112 on the oncoming lane side that corresponds to the position of pedestrian 100. Further, for example, as shown in FIG. 8(B) and FIG. 8(C), when the position of pedestrian 100 and the position of the own vehicle becomes relatively close, bright line 114 is irradiated in a blinking manner so as to overlap a portion of white line 112 on the oncoming lane side that corresponds to the closer position of pedestrian 100.

Then, irradiation position of bright line 114 is caused to change as the relative position of pedestrian 100 changes. Further, when the pedestrian moves from outside the white line to inside the white line, bright line 114 is switched to blinking irradiation. For example, if pedestrian 100 is outside the white line far from the own vehicle at one timing, and pedestrian 100 moves inside the white line at the next timing, the drawing mode (continuous irradiation) shown in FIG. 7(A) transitions to the drawing mode (blinking irradiation) shown in FIG. 8(A). Further, if pedestrian 100 who is far away from the own vehicle and outside the white line at a certain timing approaches the own vehicle to become relatively close at the next timing, and then pedestrian 100 moves inside the white line at the following timing, the drawing mode transitions from the drawing mode shown in FIG. 7(A) (continuous irradiation) to the drawing mode shown in FIG. 7(B) (continuous irradiation), then to the drawing mode shown in FIG. 8(B) (blinking irradiation).

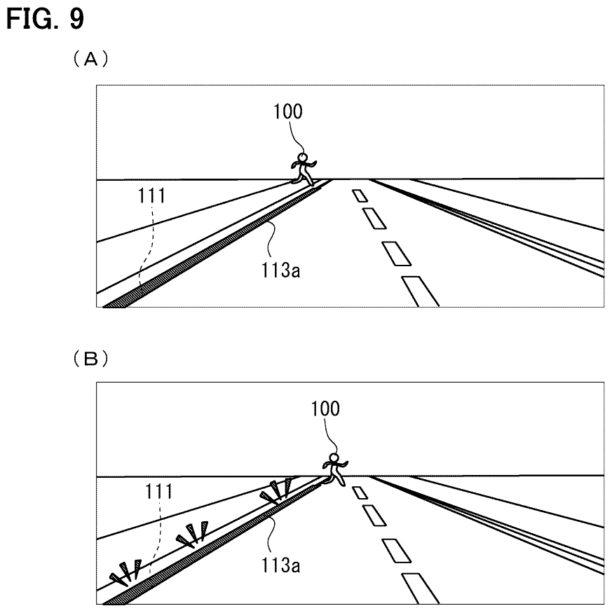

FIG. 9(A) and FIG. 9(B) are diagrams illustrating an example of a drawing mode of a bright line. In each of the previous drawing modes described above, a relatively short bright line 113 or 114 have been drawn in correspondence with the position of pedestrian 100. However, as shown in FIG. 9(A), when relative distance between pedestrian 100 and the own vehicle is greater than a certain distance, a long bright line (second bright line) 113a extending from the own vehicle position to the position of pedestrian 100 may be drawn so as to overlap white line 111.

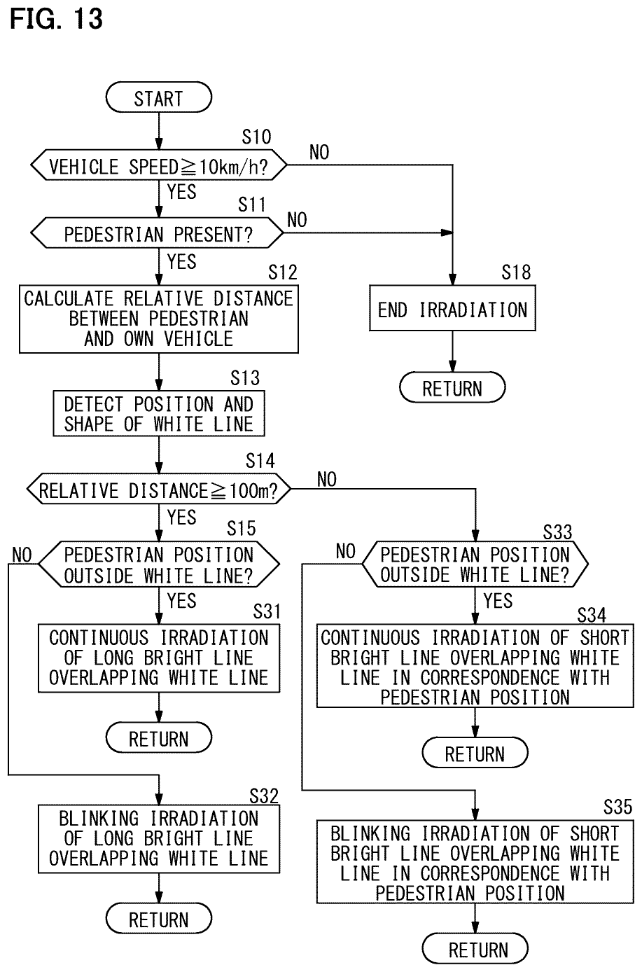

As one example, when relative distance between the pedestrian 100 and the vehicle is greater than 100 m, a relatively long bright line 113a can be irradiated, and when the relative distance is 100 m or less, a relatively short bright line 113 (refer to FIG. 5(B), etc.) can be irradiated in the same manner as the drawing mode described above. In this case, as shown in FIG. 13, the processing from step S14 onward of the flowchart shown in FIG. 4 is changed as follows. That is, after step S13, in step S14, it is determined whether relative distance to the pedestrian is 100 m or greater, and when the pedestrian's position is outside the white line in step S30, relatively long bright line 113a is irradiated in step S31, and then, when the relative distance is within 100 m in step S14 and the pedestrian is outside the white line in step S33, short bright line 113 is irradiated in step S34. Here, a relatively long bright line is a line that differs from a short bright line only in its length in the forward and backward direction and is sufficiently longer than the short bright line. As one example, length of a long bright line may be between 9 m and 100 m, which is three times or more longer than that of a short bright line.

Further, as illustrated in FIG. 9(B), when pedestrian 100 enters inside white line 111, long bright line 113a can be irradiated in a blinking manner. Also in this case, when relative distance between pedestrian 100 and the own vehicle becomes 100 m or less, a relatively short bright line 113 (refer to FIG. 5(B), etc.) is irradiated in a blinking manner, which is the same manner as in the drawing mode described above. As shown in FIG. 13, the process from step S14 onward of the flowchart shown in FIG. 4 is changed as follows. That is, after step S13, in step S14, it is determined whether the threshold value of relative distance to the pedestrian is 100 m or greater, and if the pedestrian's position in step S31 is not outside the white line (i.e., if the pedestrian is inside the white line or within the road), in step S32, relatively long bright line 113a is irradiated in a blinking manner, and thereafter, if relative distance is not 100 m or greater in step S14 (i.e., less than 100 m) and the pedestrian is not outside the white line in step S33 (i.e., if the pedestrian is inside the white line or within the road), in step S35, short bright line 113 is irradiated in a blinking manner.

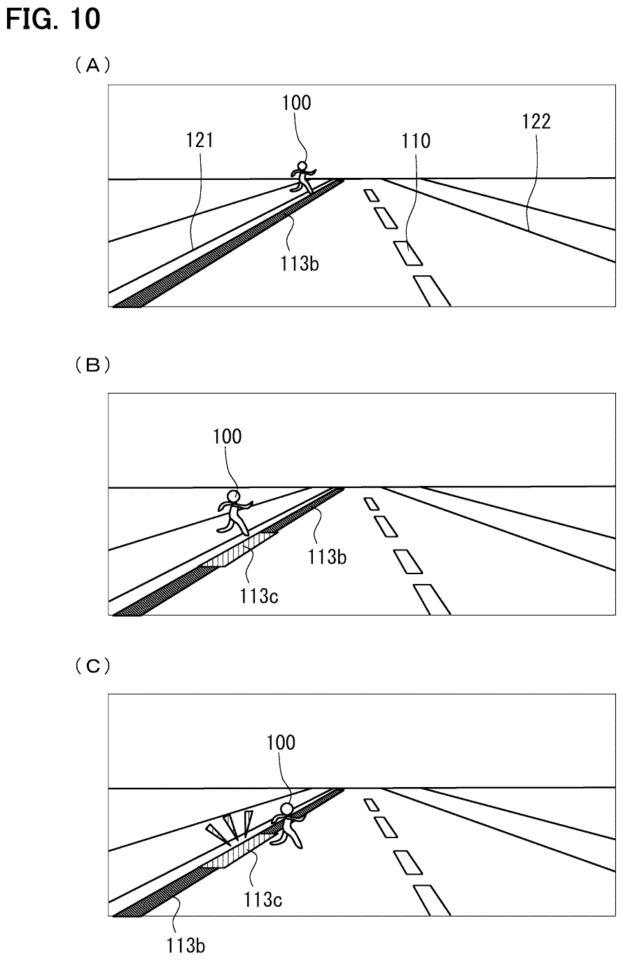

FIG. 10(A) to FIG. 10(C) are diagrams for explaining an example of the drawing mode of a bright line. Each drawing mode described above is based on the assumption that there is a white line on both sides of the own vehicle's traveling direction. However, when there is no white lines or when lines cannot be detected due to weather or the like, a long bright line 113b equivalent to the white line can be drawn as shown in FIG. 10(A). Specifically, based on white line 110 in the center of the road surface detected by image processing unit 20 and end portion contours 121, 122 on both sides of the road surface, boundary line calculation unit 25 calculates a boundary line, which is a virtual line indicating the boundary where the own vehicle and pedestrian 100 are considered to be able to travel safely. The boundary line is a virtual line extending in the extended direction of the road, and can be obtained based on the width or shape of the road.

For example, the road width which is the distance between white line 110 and end portion contour 121 can be detected, and a boundary line can be set at a fixed distance from end portion contour 121 based on the road width. Then, long bright line 113b can be drawn along the determined boundary line. This long bright line 113b can be used as an alternative to a white line, and in the present embodiment, its length is set to, for example, 100 m which is the range of a high beam from the own vehicle's position, but it can be set to within 100 m, or it can be set to 40 m which is the range of a low beam, or if the straight line distance is short, it can be shorter depending on the distance.

As shown in FIG. 10(A), when pedestrian 100 is within a first relative distance (e.g., 100 m), long bright line 113b is drawn in place of a white line. This allows the driver to intuitively recognize the presence of the pedestrian in the distance.

Further, as shown in FIG. 10(B), when relative distance between pedestrian 100 and the own vehicle becomes shorter (a second relative distance, 40 m for example), a relatively short bright line 113c which corresponds to the position of pedestrian 100 can be irradiated so as to overlap the relatively long bright line 113b. Short bright line 113c appears to irradiate onto long bright line 113b, allowing the driver to recognize the exact position of the pedestrian. At this time, it is preferable that short bright line 113c has a higher illuminance than long bright line 113b, or is irradiated with a different color tone than long bright line 113b. This is because visual recognition of short bright line 113c can be further improved. Here, note that even when the illuminance of long bright line 113b and short bright line 113c are about the same, the illuminance of the portion of bright line 113c becomes higher, so it is visually recognizable. Furthermore, as shown in FIG. 10(C), when the position of pedestrian 100 moves within bright line 113b which replaces the white line, short bright line 113c is irradiated in a blinking manner. This blinking indicates that pedestrian situation has changed, and the driver can intuitively recognize that the pedestrian has entered within the road, allowing the driver to drive while paying close attention to the pedestrian's behavior.

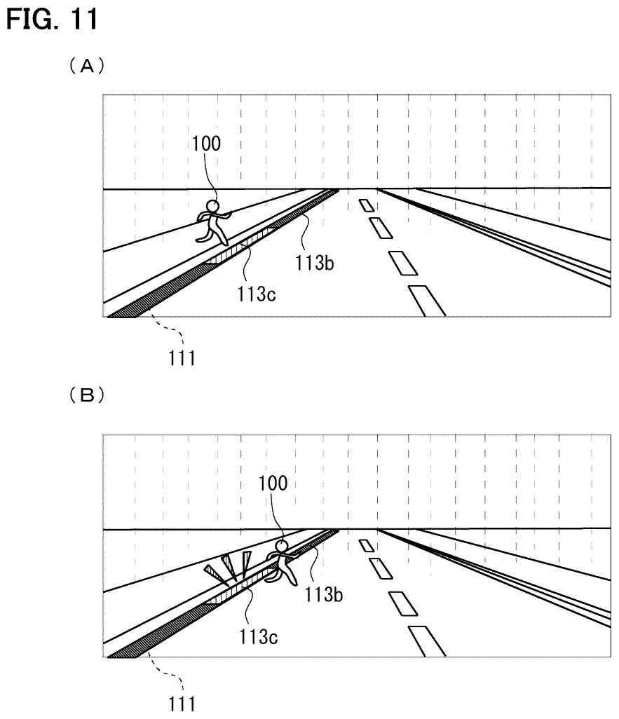

FIG. 11(A) and FIG. 11(B) are diagrams for explaining an example of the drawing mode of a bright line. When it is raining where the own vehicle is traveling, visual recognition of the bright line irradiated onto the road surface may be reduced, so it is preferable to implement a drawing mode similar to that in the case where there is no white lines as described above. The occurrence of rain is detected by weather detection unit 22 based on the output of raindrop sensor 12. For example, when the amount of rain detected exceeds a predetermined value, weather detection unit 22 outputs such a signal to road surface drawing control unit 26.

Specifically, as shown in FIG. 11(A), when pedestrian 100 is within a first relative distance (e.g., 100 m) and outside the white line, long bright line 113b can be irradiated so as to overlap white line 111, and short bright line 113c which corresponds to the position of pedestrian 100 can then be irradiated. In a road condition where the center white line 110 is difficult to recognize due to rain, even when short bright line 113c is irradiated so as to overlap center white line 110, the driver will only be able to visualize short bright line 113c, causing relative position of short bright line 113c to become unclear, and making it difficult for the driver to accurately recognize the position of the pedestrian. In the present embodiment, long bright line 113b is irradiated instead of difficult-to-see center white line 110, and short bright line 113c is seen to irradiate over long bright line 113b, causing relative position of short bright line 113c to become clear, and the driver can recognize the exact position of the pedestrian. Furthermore, as shown in FIG. 11(B), when the position of pedestrian 100 moves within long bright line 113b (within lane 111), short bright line 113c is irradiated in a blinking manner. By switching short bright line 113c irradiation to a blinking manner, the driver can intuitively recognize that the pedestrian situation has changed and the pedestrian has entered the road, and can drive while paying attention to the pedestrian's behavior. Here, it is preferable that short bright line 113c is irradiated with a higher illuminance than long bright line 113b or irradiated with a different color tone than long bright line 113b. This can further improve visual recognition of short bright line 113c.

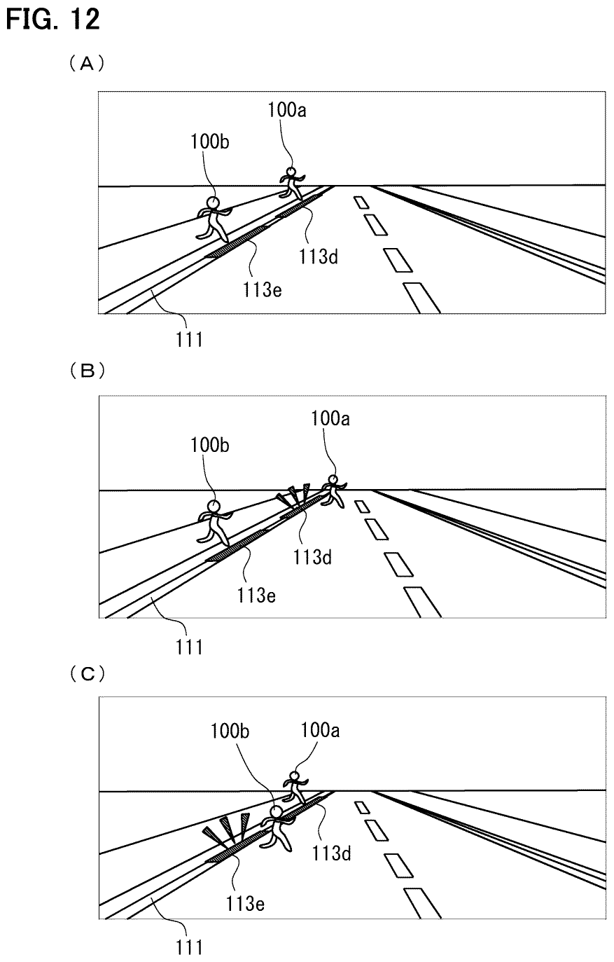

FIG. 12(A) to FIG. 12(C) are diagrams for explaining an example of the drawing mode of a bright line. When a plurality of pedestrians is present, short bright lines can be irradiated which corresponds to the position of each pedestrian. Specifically, as shown in FIG. 12(A), when a plurality of pedestrians 100a, 100b is present each of which being outside white line 111, short bright lines 113d, 113e that correspond to the positions of pedestrians 100a, 100b are irradiated. This allows the driver to recognize the exact positions of the plurality of pedestrians.

Further, as shown in FIG. 12(B), when one pedestrian 100a enters inside white line 111, bright line 113d which corresponds to this pedestrian 100a is irradiated in a blinking manner. Similarly, as shown in FIG. 12(C), when the other pedestrian 100b enters inside white line 111, bright line 113e which corresponds to this pedestrian 100b is irradiated in a blinking manner. Although illustration is omitted, when both pedestrians 100a and 100b enter inside white line 111, bright lines 113d and 113e are both irradiated in a blinking manner. As a result, multiple short bright lines 113d, 113e irradiates on white line 111, allowing the driver to recognize that the plurality of pedestrians are outside the white line (such as on the sidewalk) on the driving lane side ahead. Furthermore, when short bright lines 113d or 113e is switched to irradiate in a blinking manner, the driver can intuitively recognize that the pedestrian(s) has entered the road, so the driver can focus his/her attention to the pedestrian(s) which corresponds to the blinking short bright line among all of the plurality of pedestrians, making it easier to correspond when the pedestrian(s) approaches the vehicle.

Although detailed description will be omitted, all drawing modes can be implemented in the same manner even when pedestrian 100 is present on the side of the oncoming lane.

According to the above embodiments, by irradiating a short bright line so as to overlap a center white line or overlap a long bright line, the driver can clearly recognize the relative positions of the short bright line, therefore a road surface drawing system which can grasp the situation of a pedestrian (exact position, distance, and whether or not the pedestrian has entered the road) with good visual recognition is obtained. Specifically, due to a linear bright line along the white line on the side of the road, the presence and exact position of a pedestrian can be conveyed to the driver, and therefore the range that the driver should pay attention to is narrowed down more than when a complex light such as a T-shape is irradiated, and the pedestrian's position becomes clearly recognized. Further, narrowing down the range that the driver should pay attention to reduces the driver's eye movement. This is particularly noticeable when a pedestrian is in the distance. These make it possible to grasp the situation of a pedestrian with good visual recognition.

Further, in the present embodiment, the drawing mode of the bright line is switched from continuous irradiation to blinking irradiation depending on the pedestrian's position relative to the white line (inside the white line or outside the white line), making it easier to grasp situation change of the pedestrian. Further, since the drawing mode of the bright line is switched even in bad weather or when the white line does not exist (including when it is undetectable), this makes it easier to grasp situation change of the pedestrian. Furthermore, since the bright line is drawn toward the pedestrian's feet, there is also an advantage that it is easier to draw the pedestrian's attention who is looking down to operate his/her smartphone, for example.

Here, note that the present disclosure is not limited to the content of the above described embodiments, and various modifications can be made within the scope of the gist of the present disclosure.

The present disclosure has features as appended below.

### Appendix 1

A road surface drawing system including:
a camera for photographing a forward space of a vehicle;
a controller configured to detect a pedestrian present in the forward space of the vehicle based on image data obtained by the camera, to detect a white line on a road ahead of the vehicle, and to control irradiation of light onto the road based on each of the detection results; and
a lamp unit that irradiates light onto the road under the control of the controller,
where the controller is configured to control the lamp unit such that, when the pedestrian is present and relative distance between the pedestrian and the vehicle is equal to or less than a threshold value, a first bright line is irradiated to a position on the road which corresponds to the position of the pedestrian, and
where the first bright line is a linear light beam which extends along the direction of the white line provided at an end portion of the vehicle's driving lane or oncoming lane on the road, and is irradiated so as to overlap the white line.

### Appendix 2

The road surface drawing system according to appendix 1,
where the controller is configured to control the lamp unit such that, when the pedestrian is positioned outside the white line of the road, the first bright line is continuously irradiated, and when the pedestrian is positioned inside the white line of the road, the first bright line is irradiated in a blinking manner.

### Appendix 3

The road surface drawing system according to appendix 1 or 2,
where the controller is configured to control the lamp unit such that, when the pedestrian is present in the forward space and the relative distance between the pedestrian and the vehicle is greater than the threshold value, a second bright line which is a linear light longer than the first bright line is caused to irradiate so as to overlap the white line.

### Appendix 4

The road surface drawing system according to appendix 3,
where the controller is configured to control the lamp unit such that, when the pedestrian is positioned outside the white line of the road, the second bright line is continuously irradiated, and when the pedestrian is positioned inside the white line of the road, the second bright line is irradiated in a blinking manner.

### Appendix 5

The road surface drawing system according to any one of appendices 1 to 4,
where irradiation position of the first bright line is changed as the position of the pedestrian changes.

### Appendix 6

The road surface drawing system according to appendix 3 or 4 further comprising a raindrop sensor,
where the controller is configured to control the lamp unit such that, when the controller detects that it is raining in the forward space based on the output of the raindrop sensor, even when the relative distance between the pedestrian and the vehicle is equal to or less than the threshold value, the second bright line is caused to continuously irradiate and the first bright line is caused to irradiate so as to overlap the second bright line.

### Appendix 7

The road surface drawing system according to appendix 6,
where the first bright line is irradiated with a higher illuminance than the second bright line and/or is irradiated with a different color tone than the second bright line.

### Appendix 8

The road surface drawing system according to any one of appendices 3 to 7,
where the controller is configured to control the lamp unit such that, when the controller is unable to detect the white line, based on the width or shape of the road, the controller calculates a boundary line which is a virtual line extending along the direction of the road and which is arranged on an end portion side of the vehicle's driving lane or the oncoming lane, the controller causes to irradiate the second bright line along the boundary line regardless of the relative distance between the pedestrian and the vehicle, and causes to irradiate the first bright line so as to overlap the second bright line.

### Appendix 9

The road surface drawing system according to appendix 8,
where the first bright line is irradiated with a higher illuminance than the second bright line and/or is irradiated with a different color tone than the second bright line.

### Appendix 10

The road surface drawing system according to any one of appendices 1 to 9,
where the controller is configured to control the lamp unit such that, when a plurality of pedestrians is present, regardless of the relative distance between each pedestrian and the vehicle, the first bright line is irradiated to each position on the road which corresponds to the position of each pedestrian.

### Appendix 11

The road surface drawing system according to appendix 10,
where, the controller is configured to control the lamp unit such that, among the plurality of pedestrians that correspond to the first bright line, when the position of at least one pedestrian is inside the road relative to the white line, the first bright line which corresponds to the pedestrian inside the road is irradiated in a blinking manner.

### REFERENCE SIGNS LIST

1: Road surface drawing system
10: Controller
11: Camera
12: Raindrop sensor
13: Vehicle speed sensor
14: Vehicle position data
20: Image processing unit
21: Vehicle position detection unit
22: Weather detection unit
23: Relative position calculation unit
24: Relative distance calculation unit
25: Boundary line calculation unit
26: Road surface drawing control unit
30L, 30R: Lamp unit
31: Driver
32: LED array
100: Pedestrian
110, 111, 112: White line
113, 114: Bright line

1. A road surface drawing system comprising:
a camera for photographing a forward space of a vehicle;
a controller configured to detect a pedestrian present in the forward space of the vehicle based on image data obtained by the camera, to detect a white line on a road ahead of the vehicle, and to control irradiation of light onto the road based on each of the detection results; and
a lamp unit that irradiates light onto the road under the control of the controller,
wherein the controller is configured to control the lamp unit such that, when the pedestrian is present and relative distance between the pedestrian and the vehicle is equal to or less than a threshold value, a first bright line is irradiated to a position on the road which corresponds to the position of the pedestrian, and
wherein the first bright line is a linear light beam which extends along the direction of the white line provided at an end portion of the vehicle's driving lane or oncoming lane on the road, and is irradiated so as to overlap the white line.

2. The road surface drawing system according to claim 1,
wherein the controller is configured to control the lamp unit such that, when the pedestrian is positioned outside the white line of the road, the first bright line is continuously irradiated, and when the pedestrian is positioned inside the white line of the road, the first bright line is irradiated in a blinking manner.

3. The road surface drawing system according to claim 1,
wherein the controller is configured to control the lamp unit such that, when the pedestrian is present in the forward space and the relative distance between the pedestrian and the vehicle is greater than the threshold value, a second bright line which is a linear light longer than the first bright line is caused to irradiate so as to overlap the white line.

4. The road surface drawing system according to claim 3,
wherein the controller is configured to control the lamp unit such that, when the pedestrian is positioned outside the white line of the road, the second bright line is continuously irradiated, and when the pedestrian is positioned inside the white line of the road, the second bright line is irradiated in a blinking manner.

5. The road surface drawing system according to claim 1,
wherein irradiation position of the first bright line is changed as the position of the pedestrian changes.

6. The road surface drawing system according to claim 3 further comprising a raindrop sensor,
wherein the controller is configured to control the lamp unit such that, when the controller detects that it is raining in the forward space based on the output of the raindrop sensor, even when the relative distance between the pedestrian and the vehicle is equal to or less than the threshold value, the second bright line is caused to continuously irradiate and the first bright line is caused to irradiate so as to overlap the second bright line.

7. The road surface drawing system according to claim 6,
wherein the first bright line is irradiated with a higher illuminance than the second bright line and/or is irradiated with a different color tone than the second bright line.

8. The road surface drawing system according to claim 3,
wherein the controller is configured to control the lamp unit such that, when the controller is unable to detect the white line, based on the width or shape of the road, the controller calculates a boundary line which is a virtual line extending along the direction of the road and which is arranged on an end portion side of the vehicle's driving lane or the oncoming lane, the controller causes to irradiate the second bright line along the boundary line regardless of the relative distance between the pedestrian and the vehicle, and causes to irradiate the first bright line so as to overlap the second bright line.

9. The road surface drawing system according to claim 8,
wherein the first bright line is irradiated with a higher illuminance than the second bright line and/or is irradiated with a different color tone than the second bright line.

10. The road surface drawing system according to claim 1,
wherein the controller is configured to control the lamp unit such that, when a plurality of pedestrians is present, regardless of the relative distance between each pedestrian and the vehicle, the first bright line is irradiated to each position on the road which corresponds to the position of each pedestrian.

11. The road surface drawing system according to claim 10,
wherein, the controller is configured to control the lamp unit such that, among the plurality of pedestrians that correspond to the first bright line, when the position of at least one pedestrian is inside the road relative to the white line, the first bright line which corresponds to the pedestrian inside the road is irradiated in a blinking manner.
